(19) United States
(12) Patent Application Publication
(10) Pub. No.: US 2025/0365518 A1
(43) Pub. Date: Nov. 27, 2025

(54) Self-Adaptive Multi-Conversion Gain Pixel

(71) Applicant: Apple Inc., Cupertino, CA (US)

(72) Inventor: Jiaju Ma, Arcadia, CA (US)

(73) Assignee: Apple Inc., Cupertino, CA (US)

(21) Appl. No.: 19/184,966

(22) Filed: Apr. 21, 2025

Related U.S. Application Data
(60) Provisional application No. 63/651,338, filed on May 23, 2024.

(51) Int. Cl. H04N 25/59; H04N 25/77

(52) U.S. Cl. CPC H04N 25/59; H04N 25/77

(57) ABSTRACT

Various structures for implementation of selective conversion gain circuitry in pixel circuits are disclosed. The conversion gain selection circuitry may include conversion gain selection gates that allow selection between full well capacity and partial well capacities in the floating diffusion region. Additional conversion gain selection circuit gates that are coupled to the gate inputs of the gates over the floating diffusion region may allow column-wise and row-wise control of the selection of the conversion gain. Implementing column-wise and row-wise control provides independent selection of the conversion gain for various pixel circuits across an image sensor. Additional circuitry and techniques are described for determining the selection of conversion gain for readouts of certain photodiodes based on readout signals from previous photodiodes.

### CROSS REFERENCE TO RELATED APPLICATIONS

The present application claims priority to U.S. Provisional App. No. 63/651,338, entitled “Self-Adaptive Multi-Conversion Gain Pixel,” filed May 23, 2024, the disclosure of which is incorporated by reference herein in its entirety.

### BACKGROUND

### Technical Field

This disclosure relates generally to an image sensor and more specifically to designs of multi-conversion gain pixels for capturing light on an image sensor.

### Description of the Related Art

Image capturing devices, such as cameras, are widely used in various electronic devices, such as mobile devices (e.g., smart phones, tablets, laptops, etc.), robotic equipment, or security monitoring devices, among others. An image capturing device may include an image sensor having a plurality of light-gathering pixels. A pixel may include a photodiode. The image capturing device may capture light from an environment and pass the light to the image sensor. When exposed to light, the photodiodes of the pixels may accumulate photoelectrons. At readout, the photoelectrons may transfer out of the photodiodes and generate analog image signals. Certain image sensors are CMOS image sensors with dual-conversion-gain (DCG) pixels that read out the photoelectron signals from exposure of the photodiodes twice with two different conversion gain signals sequentially-high conversion gain (HCG) and low conversion gain (LCG). These two signals may be processed by various image signal processor circuits that digitize the signals to produce images.

### BRIEF DESCRIPTION OF THE DRAWINGS

FIG. 1 is a schematic diagram of an example DCG (dual-conversion-gain) pixel, according to some embodiments.

FIG. 2A illustrates full well capacity with a DCG (dual-conversion-gain) gate turned on for low conversion gain (LCG).

FIG. 2B illustrates partial well capacity with a DCG (dual-conversion-gain) gate turned off for high conversion gain (HCG).

FIG. 3 is a schematic diagram of a pixel circuit that includes a conversion gain selection circuit, according to some embodiments.

FIG. 4 is a top plan view of an image sensor implementing row and column logic control of conversion gain selection, according to some embodiments.

FIG. 5 depicts a plan view of a pixel circuit showing a readout and conversion gain selection process applied to the pixel circuit, according to some embodiments.

FIG. 6 is a flowchart showing an image generation process implementing a readout and conversion gain selection process for a pixel circuit, according to some embodiments.

FIG. 7 depicts a timing diagram for operation of transistors for photodiodes in a pixel circuit, according to some embodiments.

FIG. 8 depicts a schematic diagram of an analog domain implementation of feedback logic for implementation of the readout and conversion gain selection process, according to some embodiments.

FIG. 9 depicts a timing diagram for a portion of a readout involving an analog feedback circuit, according to some embodiments.

FIG. 10 depicts a schematic diagram of a digital domain implementation of feedback logic for implementation of the readout and conversion gain selection process, according to some embodiments.

FIG. 11 depicts a timing diagram for a portion of a readout involving a digital feedback circuit, according to some embodiments.

FIG. 12 depicts a timing diagram for shutter and integration of various photodiodes without dynamic refreshing, according to some embodiments.

FIG. 13 depicts a timing diagram for shutter and integration of the same various photodiodes with the addition of dynamic refreshing, according to some embodiments.

FIG. 14 is a schematic diagram of a multi-conversion-gain (MCG) pixel circuit that includes a conversion gain selection circuit, according to some embodiments.

FIG. 15 is a schematic diagram of an example image sensor, according to some embodiments.

FIG. 16 is a flowchart showing an example method for processing image signals of an image sensor to generate a digital image, according to some embodiments.

FIG. 17 illustrates a schematic representation of an example device that may include an image capturing device (e.g., a camera) having an image sensor, according to some embodiments.

FIG. 18 illustrates a schematic block diagram of an example computing device that may include or host embodiments of an image capturing device (e.g., a camera) having an image sensor, according to some embodiments.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware-for example, circuits, memory storing program instructions executable to implement the operation, etc. Reciting that a unit/circuit/component is “configured to” perform one or more tasks is expressly intended not to invoke 35 U.S.C. § 112(f) for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the intended scope. The first contact and the second contact are both contacts, but they are not the same contact.

The terminology used in the description herein is for the purpose of describing particular embodiments only and is not intended to be limiting. As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

### DETAILED DESCRIPTION

Various embodiments described herein relate to CMOS (complementary metal-oxide semiconductor) image sensors. In certain embodiments, the CMOS image sensors include dual-conversion-gain (DCG) pixels or multi-conversion-gain (MCG) pixels. DCG and MCG pixels are often used for low noise, high dynamic range (HDR) CMOS image sensor devices. A DCG pixel is capable of reading out the photoelectron signal at two different gains-either at high conversion gain (HCG) or at low conversion gain (LCG). An MCG pixel is capable of reading out the photoelectron signal at three or more different gains (e.g., LCG and at least two HCGs).

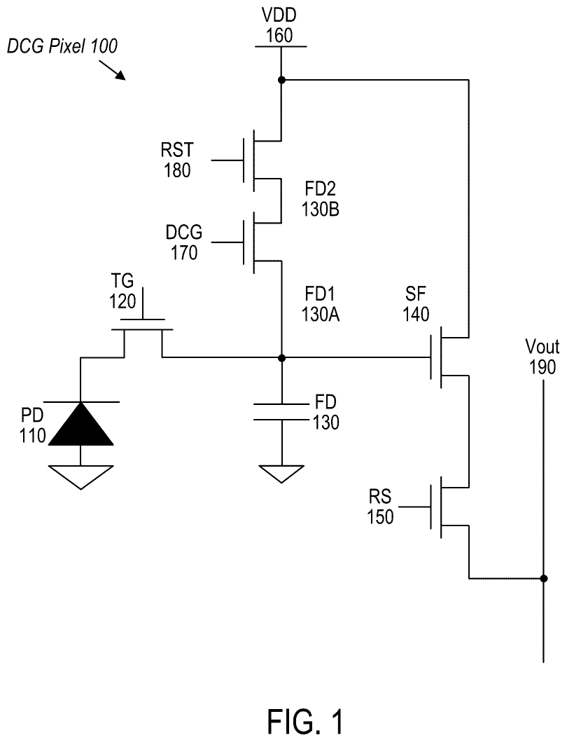

FIG. 1 is a schematic diagram of an example DCG (dual-conversion-gain) pixel, according to some embodiments. In the illustrated embodiment, DCG pixel 100 includes photodiode (PD) 110. In certain embodiments, DCG pixel 100 includes transfer gate (TG) transistor 120, floating diffusion (FD) region 130, source follower (SF) transistor 140, row selection (RS) gate transistor 150, reset voltage (VDD) 160, dual-conversion-gain (DCG) transistor 170, reset gate (RST) transistor 180, and output (Vout) 190.

In various embodiments, TG 120 may be placed in DCG pixel 100 to switch between modes of maintaining photoelectrons in PD 110 (e.g., allowing accumulation of photoelectrons in the photodiode) and releasing (e.g., transferring) photoelectrons from PD 110 to FD 130. For example, at readout, TG 120 is turned on to couple PD 110 with FD 130 and the photoelectrons may transfer from the PD to the FD. FD 130 may have capacitance and the transfer of photoelectrons into FD 130 causes a current to flow through the capacitance and generate an analog voltage. Output 190 is coupled to FD 130 through SF 140 and RS 150. RS 150 may turn on/off the output 190 based on row selection (e.g., under control signals from a row logic circuit). The voltage of FD 130 may be accessed and sampled through output 190 when RS 150 is turned on. RST 180 may be used to turn on/off a reset mode for DCG pixel 100. For instance, turning RST 180 on with DCG 170 turned on resets FD 130 to VDD 160. The various operations of gates/transistors in DCG pixel 100 may be controlled by a row logic circuit or other external circuit coupled to the DCG pixel.

In the illustrated embodiment, DCG 170 splits FD 130 into two portions—FD1 130A on a first side of DCG 170 and FD2 130B on a second side of DCG 170 (and between DCG 170 and RST 180). During operation of DCG pixel 100, turning DCG 170 on/off changes the well capacity of FD 130 to switch between LCG (full well capacity including both FD1 130A and FD2 130B) and HCG (partial well capacity of only FD1 130A). For instance, DCG 170 is turned on to enable LCG (full well capacity) and turned off to enable HCG (partial well capacity).

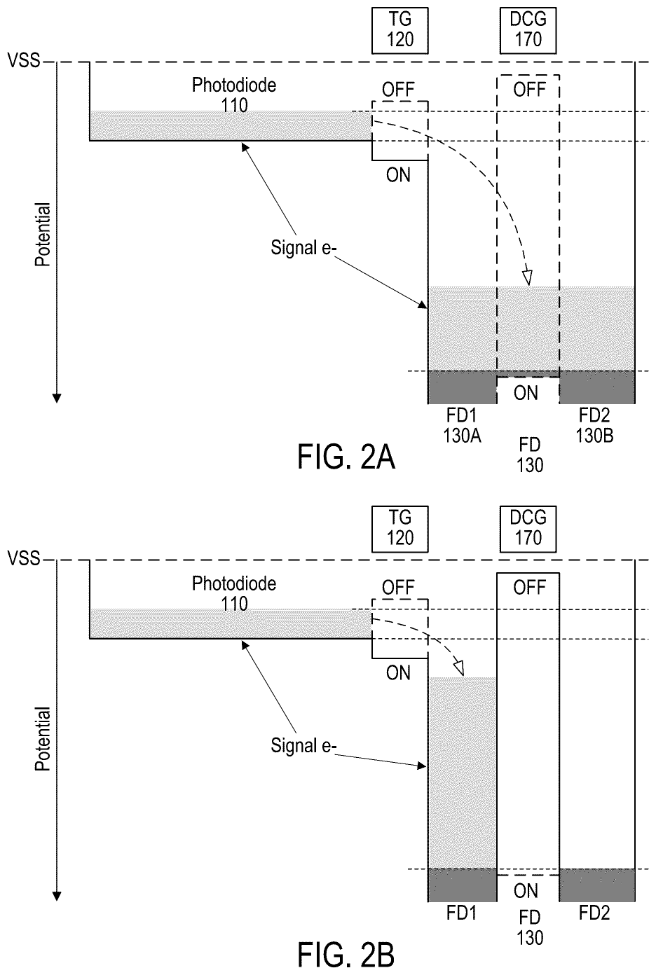

FIGS. 2A and 2B illustrate the differences in well capacities between LCG and HCG. FIG. 2A illustrates full well capacity with DCG 170 turned on for LCG. In the illustrated embodiment, DCG 170 is turned on, which lowers the barrier between FD1 130A and FD2 130B such that the photoelectrons (e.g., “signal e-”) from PD 110 can transfer through TG 120 into the full well capacity of FD 130 (e.g., both FD1 130A and FD2 130B along with the portion of FD 130 under DCG 170). FIG. 2B illustrates partial well capacity with DCG 170 turned off for HCG. In the illustrated embodiment, DCG 170 is turned off, which creates the barrier between FD1 130A and FD2 130B such that the photoelectrons (e.g., “signal e-”) from PD 110 only transfer into the partial well capacity of FD1 130A through TG 120. Accordingly, photoelectrons do not transfer to FD2 130B or the portion of FD 130 under DCG 170. With photoelectrons only transferring into FD1 130A, the signal is higher (as shown by the vertical size of shading in FD1 130A corresponding to potential)

Higher conversion gains (e.g., HCG) help reduce the input-referred read noise of the image sensor due to the higher signal. Higher conversion gains, however, utilize well capacities below the full-well capacity (FWC) of the floating diffusion (FD) region that is utilized at the low conversion gain (as shown by FIGS. 2A and 2B). Reducing the well capacity may reduce the dynamic range of the pixels. Accordingly, DCG/MCG pixels are implemented to overcome some of the trade-offs between using HCG or LCG by enabling both modes of operations. HCG modes may be useful for darker illumination conditions to reduce read noise at the low signal levels in the dark. LCG modes may be useful for brighter illumination conditions to improve FWC.

For DCG pixels, both the HCG and LCG signals are typically read out because the illumination conditions are unknown before any signal is readout of the DCG pixels. For instance, the HCG and LCG signals may be read out sequentially from a DCG pixel. For MCG pixels, each of the multiple signals may be read out sequentially. The multiple signals are then evaluated in post-capture processing to determine the appropriate gain implemented for generating the final image. Reading out every pixel multiple times for all the different conversion gains, however, increases line time, reduces frame rate, and increases power consumption.

To address these current challenges with multiple readouts in DCG/MCG pixels, the present disclosure contemplates embodiments implementing circuit architectures in DCG/MCG pixels that enable signals readout of pixels to be utilized for determining conversion gains in subsequent readouts of nearby (e.g., local or neighboring) pixels. The disclosed embodiments implement localized control of conversion gain inside pixel circuits through the implementation of row and column logic addressing of conversion gain circuits inside the image sensor. For instance, the conversion gain circuits may include gates controllable through row and column logic addressing that operate to turn on/off a dual-conversion-gain gate positioned over the floating diffusion region of a pixel circuit, as described herein.

The implementation of the row and column logic control of conversion gain circuits may be combined with control logic feedback mechanisms at the image sensor level to allow the conversion gain of a pixel to be determined based on a signal readout from a local (e.g., neighboring) pixel. In various embodiments, the conversion gain of a pixel is determined based on a signal value readout from a pixel of the same type (e.g., a same color pixel) that is local to the pixel (e.g., nearby or neighboring). For instance, for a DCG pixel, the signal value readout from the local pixel of the same type may determine whether LCG or HCG is implemented for the DCG pixel by assessing the signal value readout from the local pixel against a predetermined threshold between LCG and HCG. The disclosed control logic feedback mechanisms include embodiments implemented in either an analog domain or a digital domain associated with the image sensor. Determining the conversion gain of pixels based on signal readouts from a local pixel allows the pixels to be readout using only a single conversion gain and only one frame of data is necessary for the readout of each pixel in an image sensor. Accordingly, the architecture and readout schemes of the present disclosure enable DCG/MCG pixels to be readout with only one frame of data per pixel. The disclosed architecture and readout schemes thus enable the benefits of DCG/MCG pixels (e.g., having different gains for different illumination conditions) to be implemented without reducing frame rate or increasing power consumption as occurs with typical multiple frame readout schemes for DCG/MCG pixels.

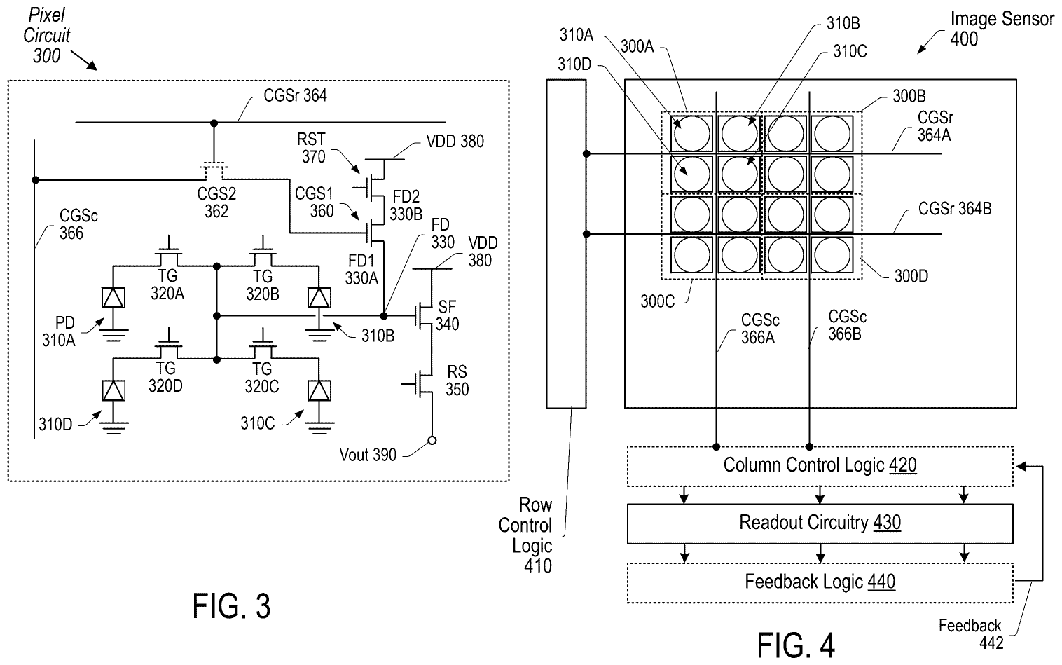

FIG. 3 is a schematic diagram of a pixel circuit that includes a conversion gain selection circuit, according to some embodiments. In the illustrated embodiment, pixel circuit 300 includes four photodiodes 310A-D. Accordingly, pixel circuit 300 is an array of four pixels corresponding to the four photodiodes 310A-D. In various embodiments, pixel circuit 300 may be part of a larger pixel array. For instance, pixel circuit 300 may be part of a Quadra color filter array (CFA) that includes a total of sixteen (16) pixels with sets of three different color pixels (e.g., four red (R) pixels, eight green (G) pixels, and four blue (B) pixels). A Quadra CFA is shown by example in the depiction of FIG. 4, described in more detail below.

In certain embodiments, photodiodes 310A-D are same color photodiodes. Accordingly, photodiodes 310A-D may accumulate photoelectrons when exposed to a same color spectrum of light. As an example, in a Quadra CFA, such as shown in FIG. 4, photodiodes 310A-D may be green light spectrum photodiodes. It should be noted that while pixel circuit 300 is shown with four photodiodes 310A-D connected to a single floating diffusion region (FD 330), other embodiments may be contemplated where the pixel circuit includes fewer or more photodiodes. For instance, in some exemplary embodiments, a pixel circuit may include only one photodiode coupled to a floating diffusion region.

In various embodiments, photodiodes 310A-D may be have corresponding target gates (TGs) 320A-D. Having individual target gates associated with each photodiode allows photoelectron accumulation in each photodiode to be readout independently through controlling operation of the target gates. For instance, readout of photodiode 310A is controlled by operation of TG 320A, which when turned on allows transfer of photoelectron accumulation from photodiode 310A to the floating diffusion region (e.g., at FD node 330).

In the illustrated embodiment of pixel circuit 300, TGs 320A-D are coupled to the floating diffusion (FD) region at FD node 330. FD nodes 330 is further coupled to source follower (SF) transistor 340, row selection (RS) gate transistor 350, the reset voltage (VDD) 380, and output (Vout) 390. As with pixel 100, shown in FIG. 1, pixel circuit 300 has a floating diffusion region (represented at FD node 330) that is separated into first portion FD1 330A and second portion FD2 330B by a conversion gain selection (CGS) gate (e.g., CGS1 360). The source of CGS1 360 is coupled to FD node 330 to have the source correspond to first portion FD1 330A with the drain of CGS1 360 corresponding to second portion FD2 330B. The drain of CGS1 360 is then coupled to reset gate (RST) 370 and reset voltage (VDD) 380.

In certain embodiments, pixel circuit 300 includes a second conversion gain selection (CGS) gate—CGS2 362. The source of CGS2 362 is coupled to the gate input of CGS1 360 allowing CGS2 362 to control operation (e.g., turning on/off) of CGS1 360. Together, CGS1 360 and CGS2 362 may form a conversion gain selection circuit that operates to control the gain of pixel circuit 300 by controlling the well capacity of the floating diffusion region. For instance, when CGS1 360 is turned on, the well capacity of the floating diffusion region is full well capacity (FWC) that includes both first portion FD1 330A and second portion FD2 330B and pixel circuit 300 has low conversion gain (LCG). When CGS1 360 is turned off, the well capacity is reduced and only includes first portion FD1 330A and pixel circuit 300 has high conversion gain (HCG).

In various embodiments, the gate input of CGS2 362 is coupled to row logic control signal CGSr 364 and the drain of CGS2 362 is coupled to column logic control signal CGSc 366. Row logic control signal CGSr 364 and column logic control signal CGSc 366 may be coupled to various control logic circuits on the image sensor to provide control of CGS2 362 that in turn controls operation (e.g., turning on/off) of CGS 360. For instance, with the gate input of CGS2 362 coupled to row logic control signal CGSr 364, the drain of CGS2 362 coupled to column logic control signal CGSc 366, and the source of CGS2 362 coupled to the gate input of CGS1 360, CGS1 360 may be controlled by the row logic control signal and the column logic control signal according to the logic operations shown in TABLE I below:

| Row logic control signal | Column logic control signal | |
|---|---|---|
| CGSr 364 | CGSc 366 | CGS1 360 |
| 1 | 1 | 1 (LCG) |
| | 0 | 0 (HCG) |
| 0 | 1 | 0 (HCG) |
| | 0 | 0 (HCG) |

As shown by TABLE 1, row logic control signal CGSr 364 and column logic control signal CGSc 366 operate through CGS2 362 with the behavior of an AND gate and CGS1 360 is only turned on when both control signals are at high levels (e.g., 1). The implementation of CGS2 362, which is coupled to the gate input of CGS1 360, in combination with row logic control signal CGSr 364 and column logic control signal CGSc 366 provides a control logic scheme for CGS1 360 that is responsive to the combination of row and column logic. Accordingly, implementing the conversion gain selection circuit in pixel circuit 300 over various pixel circuits on an image sensor allows for individualized control of gain across the various pixels of an image sensor.

FIG. 4 is a top plan view of an image sensor implementing row and column logic control of conversion gain selection, according to some embodiments. In the illustrated embodiment, image sensor 400 includes four pixel circuits 300A-D. As shown in FIG. 4, pixel circuit 300A includes a set of four photodiodes 310A-D (that correspond to the same photodiodes in FIG. 3). Similarly, each of pixel circuits 300B, 300C, 300D include a set of four photodiodes (e.g., individual pixels). In various embodiments, as discussed above, the combination of pixel circuits 300A-D may be a Quadra CFA where pixel circuits 300A and 300D both include sets of four green pixels for a total of eight green pixels (e.g., green light spectrum photodiodes). Pixel circuit 300B is a set of four blue pixels (e.g., blue light spectrum photodiodes) and pixel circuit 300C is a set of four red pixels (e.g., red light spectrum photodiodes). It should be noted that four pixel circuits 300A-D represent one unit of a Quadra CFA that may be repeated over any number of units within image sensor 400.

In the illustrated embodiment, image sensor 400 includes various control logic that includes, but is not limited to, row control logic 410, column control logic 420, readout circuitry 430, and feedback logic 440. In various embodiments, row control logic 410 outputs row logic control signals—CGSr 364A and CGSr 364B. As shown in FIG. 4, CGSr 364A and CGSr 364B pass through sets of pixels along rows in image sensor 400. In some embodiments, CGSr 364A and CGSr 364B are row logic control signals that correspond to row logic control signals for readout of pixels. For instance, CGSr 364A may correspond to a row selection control signal provided to row selection (RS) transistor 350 (shown in FIG. 3) in pixel circuits 300A and 300B. Accordingly, CGSr 364A may have a high value when readout of the row of pixel circuits 300A, 300B is requested by the row selection control signal. In other embodiments, CGSr 364A and CGSr 364B may be separate row logic control signals that are operated independently of the row selection control signals.

In certain embodiments, column control logic 420 outputs column logic control signals—CGSc 366A and CGSc 366B. As shown in FIG. 4, CGSc 366A and CGSc 366B pass through sets of pixels along columns in image sensor 400. Thus, CGSc 366A and CGSc 366B intersect with CGSr 364A and CGSr 364B to provide independent control of conversion gain selection for the sets of pixels (e.g., photodiodes) in the four depicted pixel circuits 300A-D based on the applied row and column control signals. For example, the combination of row column logic in CGSr 364A and column logic in CGSc 366A may be applied to control the conversion gain selection in pixel circuit 300A through the operation of the pixel circuit's conversion gain selection circuit (which includes CGS1 360) according to the logic operations shown in TABLE 1 above.

In various embodiments, the application of column logic control signals CGSc 366 is implemented to determine the conversion gain selection of individual pixel circuits during readout of a row of pixel circuits. For example, as noted above, CGSr 364 may correspond to the row logic control signal for readout of a row of pixel circuits. Thus, when CGSr 364 has a high value (e.g., value of 1 as shown in TABLE 1 above) for a row of pixel circuits, the pixel circuits in the row are being addressed for readout by the row logic control signal. In such situations, the conversion gain for an individual pixel circuit may be switched (e.g., selected or determined) between LCG and HCG based on the corresponding CGSc 366 value applied to the pixel circuit and according to the logic operations in TABLE 1. For instance, providing a high value for the corresponding CGSc 366 sets the conversion gain at LCG for the pixel circuit while providing a low value for the corresponding CGSc 366 sets the conversion gain at HCG for the pixel circuit. Accordingly, the implementation of column control logic, in combination with the row control logic, allows for individualized control of conversion gain selection based on individually addressing selected columns or rows of pixel circuits in the image sensor.

In various embodiments, readout circuitry 430, shown in FIG. 4, implements pixel signal readout of the various pixel circuits 300 in image sensor 400. In certain embodiments, readout circuitry 430 is column readout circuitry that reads out pixel signal values along columns of pixel circuits in image sensor 400. Thus, row selection may be implemented in combination with the column readout circuitry to provide readouts of selected rows along the columns of pixel circuits in image sensor 400.

In various embodiments, the pixel signal readouts obtained by readout circuitry 430 are provided to feedback logic 440. In certain embodiments, feedback logic 440 includes control logic that determines conversion gains to be set for pixels in image sensor 400 based on pixel signal readouts from other local (e.g., neighboring) pixels. For example, feedback logic 440 may provide feedback 442 to column control logic 420. Feedback 442 may include a determination of the conversion gain to be applied to a pixel (e.g., through control of CGSc 366 for a specific column) based on a pixel signal that has been readout. Feedback 442 may, accordingly, be received by column control logic 420 and implemented to determine the value for a specific column logic control signal CGSc 366 and control the conversion gain selection in the pixel circuit along the specific column during readout of a specific row (as selected by row control logic 410).

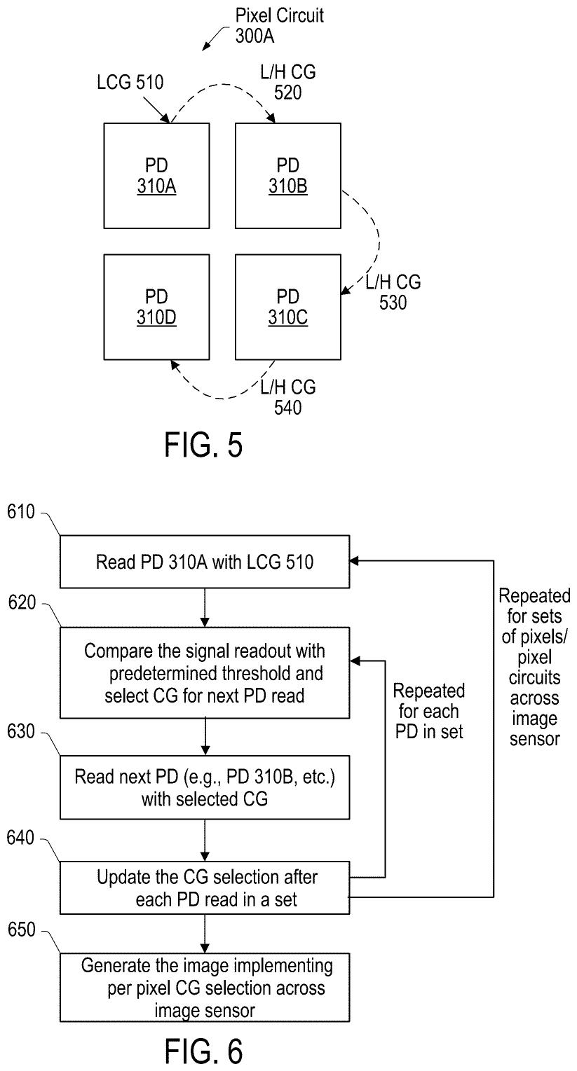

FIG. 5 depicts a plan view of a pixel circuit showing a readout and conversion gain selection process applied to the pixel circuit, according to some embodiments. In the illustrated embodiment, pixel circuit 300A includes a set of four photodiodes (pixels) 310A-D. Pixel circuit 300A may be, for example, a 2×2 pixel circuit for a set of common color photodiodes that is part of a Quadra CFA, as described herein. While the process of a readout and conversion gain selection process is shown with respect to a set of four pixels by example, it should be understood that the readout and conversion gain selection process described herein may be applied to any numbered set of multiple photodiodes (e.g., pixels) in a pixel circuit or any other set of photodiodes. There may, however, be limitations on the types of pixels implemented in the disclosed readout and conversion gain selection process. For instance, the conversion selection process based on readouts of previous pixels in a sequence may be limited to same color pixels (photodiodes) as different colored pixels may not have pixel readout signals that are suitable for comparison and conversion gain selection as described herein. Embodiments may, however, be contemplated where a pixel readout signal from one color pixel may be implemented in determining conversion gain selection for different color pixels (e.g., by applying normalization or another conversion process to the pixel readout signals).

In various embodiments, readouts of accumulated photoelectrons in each photodiode are conducted sequentially. For instance, as shown by the arrows in FIG. 5, photodiode 310A may be readout first followed by photodiode 310B, then photodiode 310C, and then photodiode 310D. This intra-pixel circuit sequential readout process may be conducted pixel circuit by pixel circuit across a row of an image sensor as selected by row control logic 410, shown in FIG. 4. The process is then repeated across additional rows to get full readouts of all or a selected number of pixels on the image sensor. As described herein, an image may then be generated from the readouts of the pixels across the image sensor.

FIG. 6 is a flowchart showing an image generation process implementing a readout and conversion gain selection process for pixel circuit 300A, according to some embodiments. The readout and conversion gain selection In 610, photodiode 310A is readout with LCG 510 applied in the pixel circuit (also shown in FIG. 5) for readout of the photodiode (e.g., pixel). At 620, the pixel signal readout from photodiode 310A with LCG 510 is compared to a predetermined threshold to select the conversion gain (CG) for the next photodiode to be readout (e.g., photodiode 310B). For instance, the pixel signal readout from photodiode 310A is compared to a predetermined threshold to determine (e.g., select) whether conversion gain 520 for photodiode 310B is low (L) or high (H) (as shown in FIG. 5). For instance, in some contemplated embodiments, the conversion gain may be selected as low (LCG) when the pixel signal readout is above (e.g., satisfies) a predetermined threshold while the conversion gain is selected as high (HCG) when the pixel signal readout is below (e.g., does not satisfy) the predetermined threshold. LCG may be selected when the pixel signal readout is above the predetermined threshold as such a determination may indicate that the pixel signal readout has a high amount of signal (e.g., accumulated photoelectrons) corresponding to brighter illumination conditions suitable for LCG.

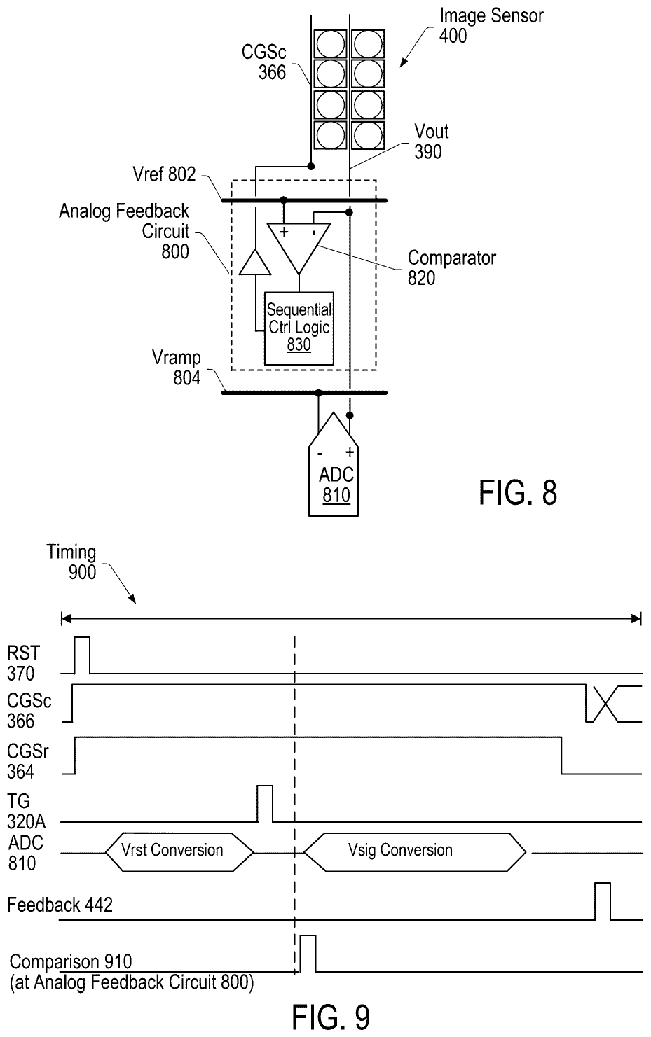

In certain embodiments, the comparison of the signal readout to the predetermined threshold is orchestrated by feedback logic 440 and the selection of conversion gain 520 for photodiode 310B is provided to column control logic 420 as feedback 442, shown in FIG. 4. In some contemplated embodiments, feedback logic 440 implements the comparison in an analog domain (as shown and described for FIG. 8). In other contemplated embodiments, feedback logic 440 implements the comparison in a digital domain (as shown and described for FIG. 9).

At 630, the next photodiode after the previous photodiode (e.g., photodiode 310B after photodiode 310A) is readout at the conversion gain (e.g., LCG or HCG) selected at 620. If there are additional pixels (e.g., photodiodes) in the set to still be readout, then at 640 it is determined to update the CG selection based on the readout of the current photodiode (e.g., photodiode 310B). The process then returns to 620 to compare the signal readout for photodiode 310B and determine the conversion gain selection for the next photodiode—photodiode 310C. These steps are repeated until every photodiode in the set (e.g., pixel circuit 300A) is readout according to the conversion gain selected for the photodiode based on the previous signal readout (other than the first photodiode that is readout at LCG). For example, as shown in FIG. 5, photodiode 310B is readout with CG 520 (selected as either L or H), photodiode 310C is readout with CG 530 (selected as either L or H), and photodiode 310D is readout with CG 540 (selected as either L or H). Updating the conversion gain selection for each photodiode in pixel circuit 300A based on the previously readout pixel signal maintains consistency of selected conversion gain across the pixel circuit and reduces the potential for artifacts in the images created by differences across the images.

Turning back to FIG. 6, as described herein, after the photodiodes in a set of photodiodes (e.g., a pixel circuit) are readout, readout may move to another set of photodiodes in the image sensor. In some embodiments, the next set of photodiodes may be different color photodiodes or photodiodes that are spatially separated from the previous set of photodiodes, the readout and conversion gain selection process for the next set may begin by using LCG for the first photodiode in the set again at 610, as shown in FIG. 6. Other embodiments may be contemplated, however, where a readout of a first photodiode in an adjacent set of photodiodes begins by selecting the conversion gain based on the readout from the last photodiode in the previous adjacent set. In either of these embodiments, the process for the multiple sets of photodiodes (e.g., sets of pixel circuits) across the image sensor may be repeated until all or a predetermined number of sets/pixel circuits are readout. After completion of the gathering of all the pixel signal readouts, an image implementing the per pixel conversion gain selection may be generated for the image sensor at 650.

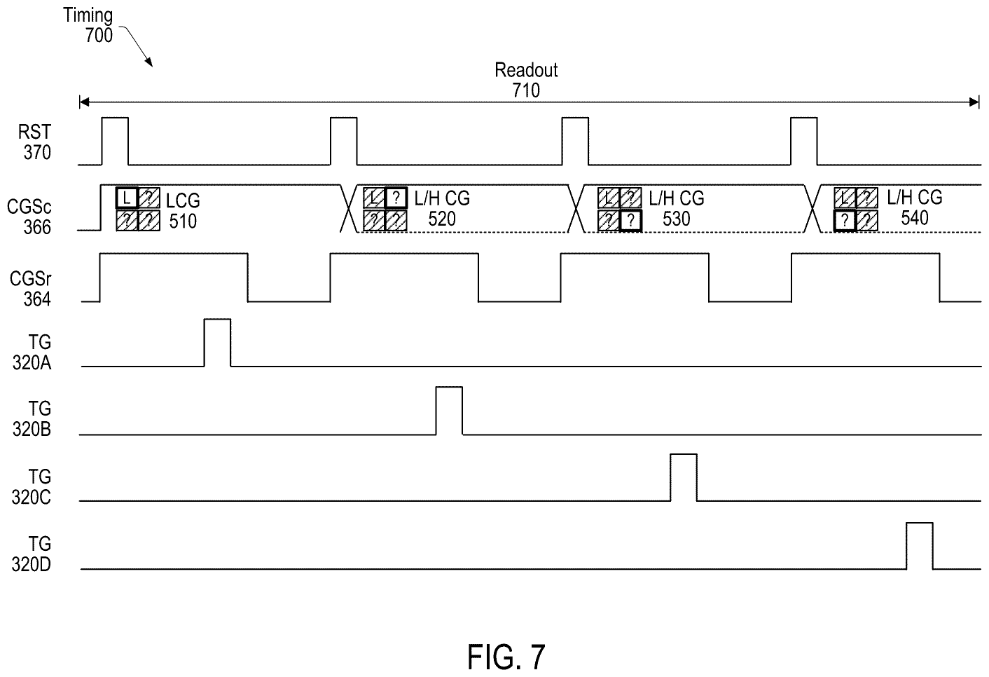

The readout and conversion gain selection process described for the embodiments of FIGS. 5 and 6 is further described with reference to the timing diagram illustrated in FIG. 7. FIG. 7 depicts a timing diagram for operation of transistors for photodiodes in pixel circuit 300A of FIG. 5, according to some embodiments. Timing 700 is implemented for the set of four photodiodes 310A-D through operation of their corresponding transfer gate (TG) transistors—TG 320A, TG 320B, TG 320C, TG 320D (as shown in FIG. 3). TGs 320A-D have corresponding curves in timing 700 of FIG. 7. As also shown in FIG. 3, these four transfer gate (TG) transistors are coupled to reset gate (RST) transistor 370, which also has a corresponding curve in the timing 700 of FIG. 7, through CGS1 360 and CGS2 362. As described herein, the operation of CGS1 360 and CGS2 362 are controlled by the control signals—CGSr 364 and CGSc 366 (which have corresponding curves in timing 700 of FIG. 7). It should be noted that in the illustrated embodiment, only the readout portion (e.g., readout 710) of timing 700 for pixel circuit 300A for these transistors is illustrated. Other portions of the timing of the pixel circuit (e.g., shuttering, integration, and idle) as well as operations of other transistors in the pixel circuit are not shown for simplicity in the drawing.

As shown in FIG. 7, pixel circuit 300A is readout by implementing sequential readout pulses for TG 320A, TG 320B, TG 320C, TG 320D along with corresponding resets through RST 370 between the readout pulses. Row logic control signal CGSr 364 (e.g., the row selection readout signal) is maintained at high during each of the readouts for each transfer gate (TG) 320A-D and then turned to low between the readouts (e.g., after the corresponding TG is turned off) as shown by the pulsed curve. Additionally, as described above, column logic control signal CGSc 366 is varied to select (e.g., switch) between LCG or HCG being applied to the pixel circuit for each photodiode/transfer gate readout. For instance, CGSc 366 is high during readout of TG 320A to apply LCG 510 (as shown in FIG. 5) as the conversion gain for the pixel circuit during the readout. Then, for readout of TG 320B, CGSc 366 is either high (solid line) or low (dashed line) to apply LCG or HCG, respectively, for L/H CG 520 based on the feedback from the readout of TG 320A, as described herein. Similar logic is then applied to the selection of CGSc 366 for the readout of TG 320C and L/H CG 530 and the readout of TG 320D and L/H CG 540.

FIG. 8 depicts a schematic diagram of an analog domain implementation of feedback logic for implementation of the readout and conversion gain selection process, according to some embodiments. In the illustrated embodiment, analog feedback circuit 800 is coupled to a column of pixel circuits in image sensor 400 to receive Vout 390 (e.g., the pixel circuit readout signal, shown in FIG. 3) and provide CGSc 366 (e.g., column logic control signal). Analog feedback circuit 800 may be associated with column control logic 420 and/or feedback logic 440, shown in FIG. 4, and provide a per column basis analysis of Vout 390 for determining CGSc 366. In various embodiments, as shown in FIG. 8, analog feedback circuit 800 is tied between a reference voltage (Vref 802) and a ramp voltage (Vramp 804). Analog feedback circuit 800 is positioned to receive Vout 390 and provide a comparison/selection of conversion gain in the analog domain before the analog signal is readout by ADC 810.

In the illustrated embodiment, analog feedback circuit 800 includes comparator 820 and sequential control logic 830. Comparator 820 may provide a comparison of Vout 390 against a predetermined threshold. The predetermined threshold may be, for example, a threshold of illumination that distinguishes between instances where LCG is preferred (e.g., bright illumination situations) and where HCG is preferred (e.g., darker illumination situations). Sequential control logic 830 may then respond to the comparison to provide the control signal appropriate to select the conversion gain as LCG or HCG for the next pixel readout (e.g., either a high value of CGSc 366 for

LCG or a low value of CGSc 366 for HCG). In some embodiments, comparator 820 and sequential control logic 830 are part of feedback logic 440, shown in FIG. 4, with feedback 442 being provided to column control logic 420 to determine a value of CGSc 366 for selection of the conversion gain. In other embodiments, comparator 820 may be part of feedback logic 440 with sequential control logic 830 being a part of column control logic 420 and feedback 442 being provided from the comparator to the sequential control logic to determine a value of CGSc 366.

FIG. 9 depicts a timing diagram for a portion of a readout involving analog feedback circuit 800, according to some embodiments. In the illustrated embodiment, timing 900 includes the portion of timing for reading out the pulse for transfer gate (TG) 320A, which corresponds to photodiode 310A. As shown in FIG. 9, CGSr 364 and CGSc 366 are set at high for LCG during the readout of TG 320A. Comparison 910 is implemented by analog feedback circuit 800, which may be part of feedback logic 440, after conversion of the reset voltage (Vrst) readout by ADC 810 but before conversion of the signal voltage (Vsig) readout by ADC 810, as shown by the vertical dotted line. Subsequently following the signal voltage readout and conversion, feedback 442 may be provided to determine a value for CGSc 366 in the readout of the next photodiode/transfer gate.

As shown in FIG. 8, a global voltage buffer (e.g., Vref 802) is necessary for analog feedback circuit 800 as the comparison and determination of the control signal is being completed in the analog domain. Implementation of the global voltage buffer may increase power consumption for operation of the image sensor. Various embodiments may be contemplated to implement the feedback logic for the readout and conversion gain selection process in the digital domain to inhibit increasing the power consumption for such a process.

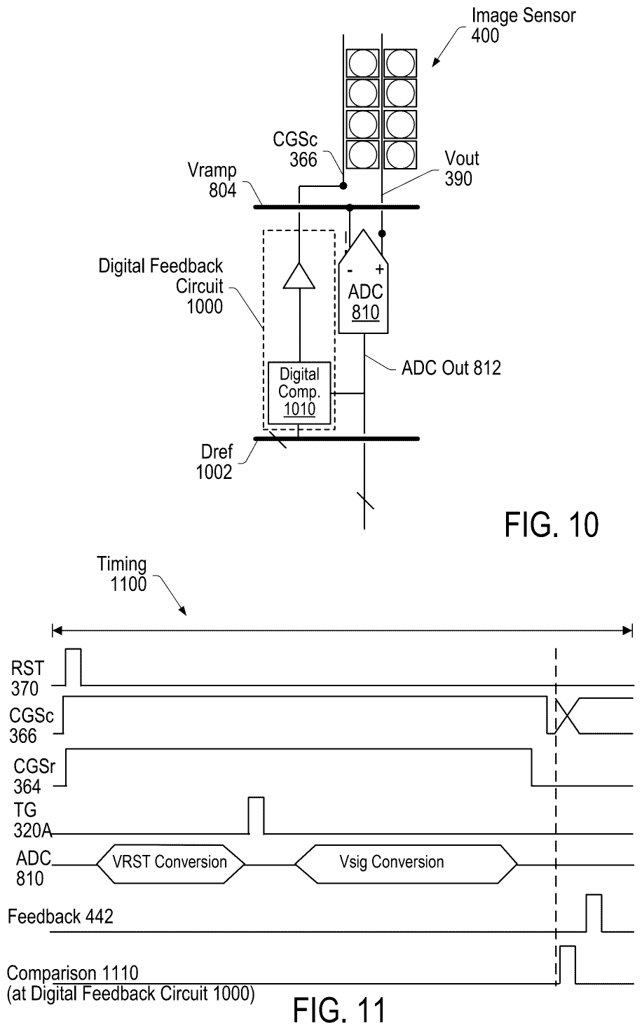

FIG. 10 depicts a schematic diagram of a digital domain implementation of feedback logic for implementation of the readout and conversion gain selection process, according to some embodiments. In the illustrated embodiment, digital feedback circuit 1000 is coupled to a column of pixel circuits in image sensor 400 to receive Vout 390 (e.g., the pixel circuit readout signal, shown in FIG. 3) and provide CGSc 366 (e.g., column logic control signal). Digital feedback circuit 1000 may be associated with column control logic 420 and/or feedback logic 440, shown in FIG. 4, and provide a per column basis analysis of Vout 390 for determining CGSc 366. In various embodiments, as shown in FIG. 10, digital feedback circuit 1000 is coupled to a digital reference (Dref 1002) to provide a basis for comparison of the signal output to a reference value.

In the illustrated embodiment, digital feedback circuit 1000 includes digital comparator 1010. Digital comparator 1010 is coupled to the output of ADC 810 to receive ADC Out 812, which is a digital conversion of Vout 390. Accordingly, digital comparator 1010 provides a comparison/selection of conversion gain in the digital domain after the analog signal is readout by ADC 810. Digital comparator 1010 may provide a comparison of ADC Out 812 against a predetermined threshold. The predetermined threshold may, for instance, be set by Dref 1002. Digital comparator 1010 may respond to the comparison to provide the control signal appropriate to select the conversion gain as LCG or HCG for the next pixel readout (e.g., either a high value of CGSc 366 for LCG or a low value of CGSc 366 for HCG). In some embodiments, digital comparator 1010 is part of feedback logic 440, shown in FIG. 4, with feedback 442 being provided to column control logic 420 to determine a value of CGSc 366 for selection of the conversion gain. In other embodiments, digital comparator 1010 may be part of column control logic 420.

FIG. 11 depicts a timing diagram for a portion of a readout involving digital feedback circuit 1000, according to some embodiments. In the illustrated embodiment, timing 1100 includes the portion of timing for reading out the pulse for transfer gate (TG) 320A, which corresponds to photodiode 310A. As shown in FIG. 11, CGSr 364 and CGSc 366 are set at high for LCG during the readout of TG 320A. Comparison 1110 is implemented by digital feedback circuit 1000 after conversion of the signal voltage (Vsig) by ADC 810, as shown by the vertical dotted line. Feedback 442 is subsequently provided to determine a value for CGSc 366 in the readout of the next photodiode/transfer gate.

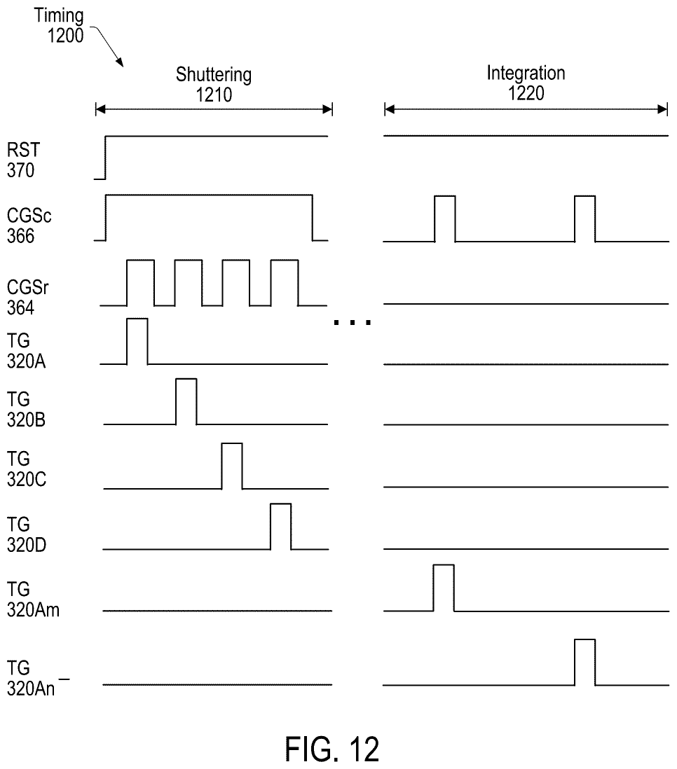

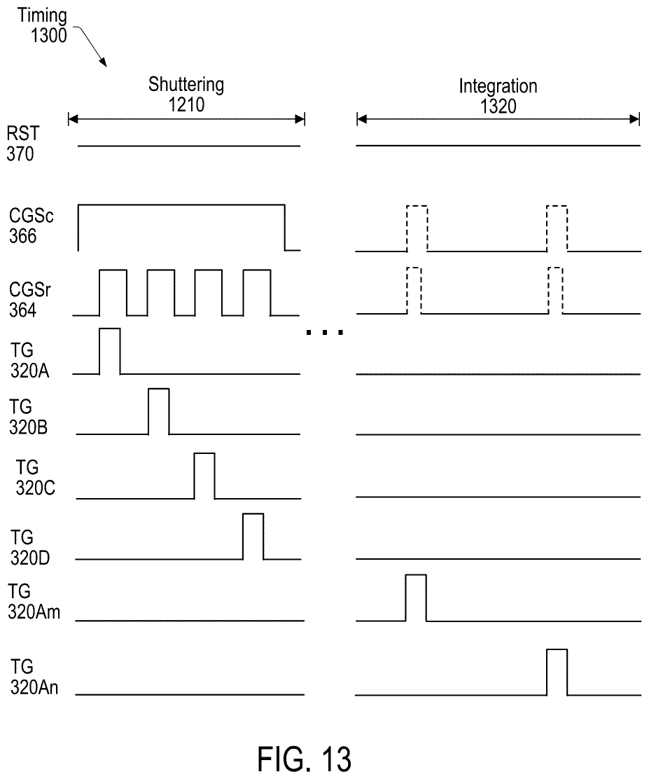

In some contemplated embodiments, dynamic refreshing of pixel circuits may be implemented by taking advantage of the various circuit elements described herein. For instance, the LCG read cycles for sets of photodiodes described above may be leveraged to turn on conversion gain selection gates during integration and dynamically refresh some photodiodes by simultaneously pulsing transfer gates for these photodiodes. FIG. 12 depicts a timing diagram for shutter and integration of various photodiodes without dynamic refreshing, according to some embodiments. FIG. 13 depicts a timing diagram for shutter and integration of the same various photodiodes with the addition of dynamic refreshing, according to some embodiments.

As shown in FIG. 12, timing 1200 includes shuttering 1210 and integration 1220. During shuttering 1210, RST 370 and CGSc 366 are turned on while CGSr 364 is pulsed in accordance with each of the transfer gates (TGs) 320A-D to reset (e.g., drain) the photodiodes corresponding to each transfer gate. While the resetting of TGs 320A-D is occurring during shuttering 1210, additional transfer gates that are the first transfer gates in sets of photodiodes to be readout (e.g., represented by TG 320An and TG 320Am) remain turned off. Note that these transfer gates—TG 320An and TG 320Am—are transfer gates that correspond to photodiodes that are readout first in a set of photodiodes using LCG for the conversion gain, as described herein, and that these transfer gates/photodiodes are not subject to the selection of conversion gain based on feedback from other photodiode readouts.

Integration 1220 for TGs 320A-D follows shuttering 1210. During integration 1220, photoelectrons are accumulated in the photodiodes corresponding to TGs 320A-D. During this time, TG 320An and TG 320Am are turned on to inhibit accumulation of photoelectrons in the corresponding photodiodes. Turning now to FIG. 13, in timing 1300, shuttering 1210 remains unchanged while integration 1320 changes the timing of CGSr 364 to provide dynamic refreshing of the photodiodes and pixel circuits corresponding to TG 320An and TG 320Am. Dynamic refreshing is enabled by pulsing CGSr 364 along with CGSc 366, TG 320An, and TG 320Am. Accordingly, dynamic refreshing of these photodiodes and pixel circuits is achieved without the addition of any circuitry beyond the circuitry depicted in the present disclosure.

While the disclosed embodiments describe various readout and conversion gain selection implementations for dual-conversion-gain (DCG) pixel circuits that select between a low conversion gain (LCG) and a high conversion gain (HCG), it should be understood that embodiments of multi-conversion-gain (MCG) pixel circuits may also be contemplated according to the disclosed embodiments. For example, an additional floating diffusion portion may be created by adding another conversion gain selection (CGS) circuit gate between the floating diffusion region and the reset transistor along with an additional CGS circuit gate that has additional column control logic and row control logic applied to it. For such embodiments, additional column-wise control logic may be added to implement the additional column control logic while either the same or additional row-wise control logic may be utilized.

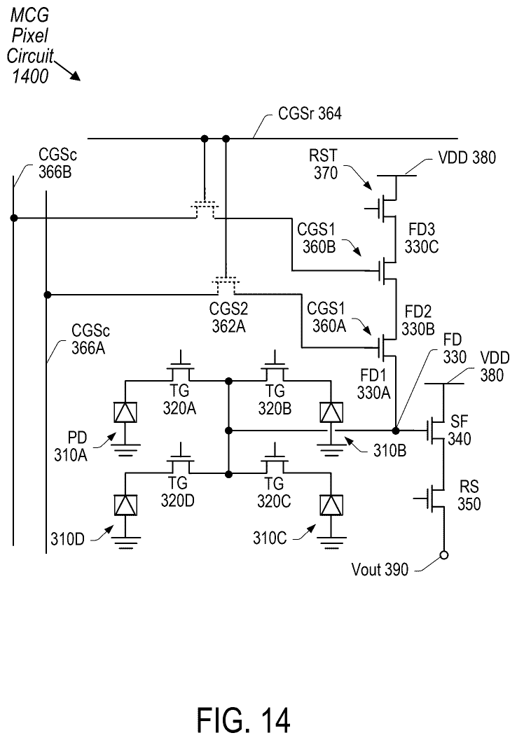

FIG. 14 is a schematic diagram of a multi-conversion-gain (MCG) pixel circuit that includes a conversion gain selection circuit, according to some embodiments. In the illustrated embodiment, MCG pixel circuit 1400 includes four photodiodes 310A-D, four transfer gates (TGs) 320A-D, floating diffusion (FD) node 330, source follower (SF) transistor 340, row selection (RS) transistor 350, reset (RST) transistor 370, VDD 380, and Vout 390, as are also depicted in the illustration of FIG. 3. The conversion gain selection (CGS) circuit of FIG. 14 includes two first conversion gain selection (CGS) gates—CGS1 360A and CGS1 360B—that separate the floating diffusion region into three portions—FD1 330A, FD2 330B, and FD3 330C—between the FD node 330 and RST 370.

The CGS of MCG pixel circuit 1400 further includes two second conversion gain selection gates—CGS2 362A and CGS2 362B. The source of CGS2 362A is coupled to the gate input of CGS1 360A and the source of CGS2 362B is coupled to the gate input of CGS1 360B. The gate inputs of CGS2 362A and CGS2 362B are coupled to CGSr 364 (e.g., the row control logic signal). Note that some embodiments may be contemplated where separate row control logic signals are provided to CGS2 362A and CGS2 362B. The drain of CGS2 362A is coupled to a first column control logic signal CGSc 366A and the drain of CGS2 362B is coupled to a second column control logic signal CGSc 366B. Accordingly, separately column control logic signals can be provided to CGS2 362A and CGS2 362B for independent operation of the selection of conversion gains associated with turning on/off gates CGS1 360A and CGS1 360B.

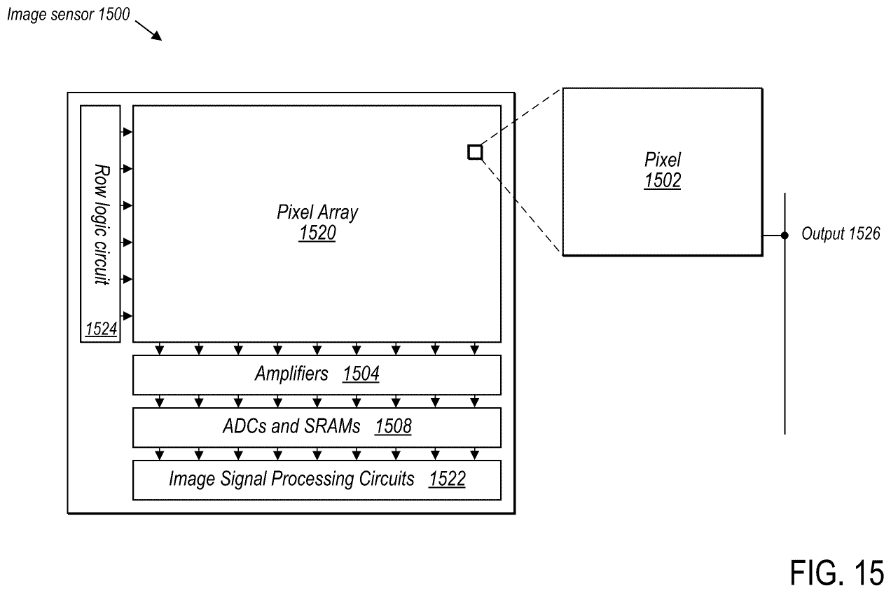

FIG. 15 is a schematic diagram of an example image sensor, according to some embodiments. As shown in FIG. 15, image sensor 1500 may include a plurality of light-gathering pixels 1502 (e.g., square PD pixel structures or split PD pixel structures as described herein) organized as a pixel array 1520. In some embodiments, image sensor 1500 may include one or more amplifiers 1504, one or more ADC (analog-to-digital conversion) circuits and memory 1508, and one or more image signal processing circuits 1522. In various embodiments, image signal processing circuits include data interface circuits. In some embodiments, image signals of pixels 1502 of pixel array 1520 may be read out row-by-row or column-by-column (or even pixel-by-pixel). For purposes of illustration, in this example, image sensor 1500 may also include row logic circuit 1524 to provide control signals to perform row-by-row readout of pixels 1502. Using the row-by-row readout, pixels 1502 on the same row may be read out at or around the same time, whereas pixels 1502 on the same column but different rows may be read out sequentially one row after another.

In some embodiments, the above readout of image signals of pixels 1502 may be implemented using one or more readout circuits, as described herein. For example, at least some of pixels 1502 may include one or more photodiodes and a pixel readout circuit. The photodiodes may generate and accumulate photoelectrons when exposed to light. During readout, under control signals from row logic circuit 1524, a row selection transistor and a source follower transistor may be turned on and release analog signal output through output 1526. Output 1526 may be coupled to a floating diffusion region that, depending on the state of a transfer gate and a reset gate may output an analog output signal with a reset value or a signal value.

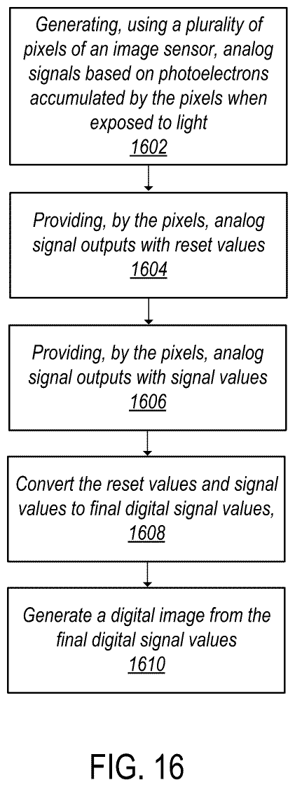

FIG. 16 is a flowchart showing an example method for processing image signals of an image sensor to generate a digital image, according to some embodiments. In FIG. 16, in some embodiments, in a photodiode of at least one pixel on an image sensor, photoelectrons are accumulated in response to the at least one pixel being exposed to light, as shown by block 1602. During readout, these photoelectrons may transfer out of the photodiodes to generate analog signal outputs (e.g., analog voltage outputs) at FD regions of the pixels, which may be further accessed at the output of the pixels. In FIG. 16, in some embodiments, the pixels provide analog signal outputs with reset values at block 1604. At block 1606, the pixels provide analog signal outputs with signal values. Then, at block 1608, the reset values and the signal values are converted to final digital signal values. In various embodiments, the final digital signal values are generated by a combination of ADCs, SRAMs, digital processing circuits, and data interface circuits. At block 1610, a digital image is generated from the final digital signal values. For example, digital processing circuits and/or data interface circuits may generate the digital image from the final digital signal values.

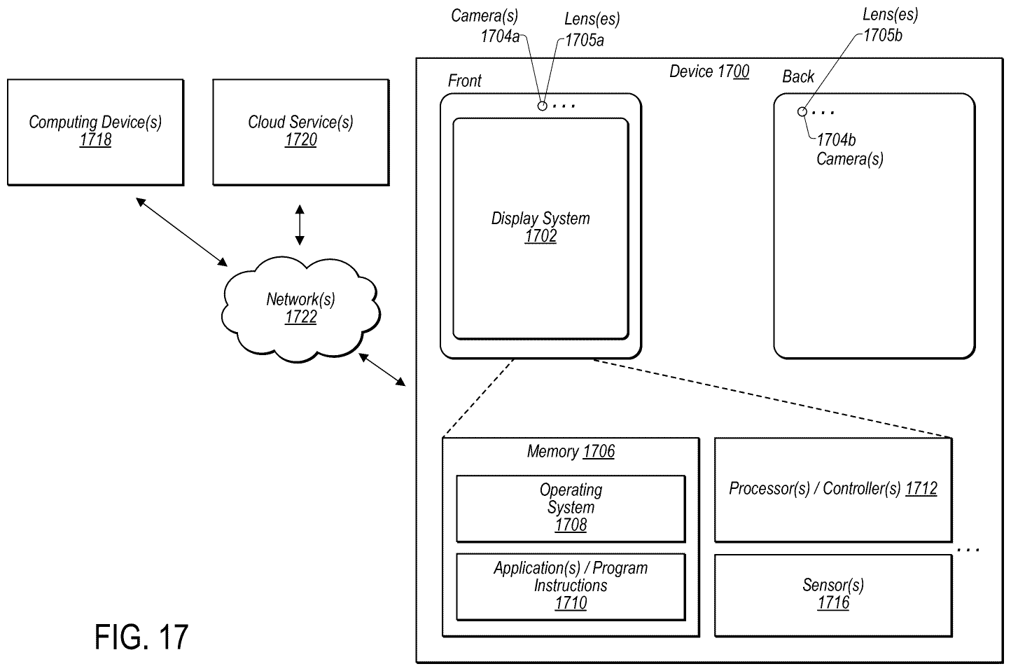

FIG. 17 illustrates a schematic representation of an example device 1700 that may include an image capturing device (e.g., a camera) having an image sensor, according to some embodiments. In some embodiments, the device 1700 may be a mobile device and/or a multifunction device. In various embodiments, the device 1700 may be any of various types of devices, including, but not limited to, a personal computer system, desktop computer, laptop, notebook, tablet, slate, pad, or netbook computer, mainframe computer system, handheld computer, workstation, network computer, a camera, a set top box, a mobile device, an augmented reality (AR) and/or virtual reality (VR) headset, a consumer device, video game console, handheld video game device, application server, storage device, a television, a video recording device, a peripheral device such as a switch, modem, router, or in general any type of computing or electronic device.

In some embodiments, the device 1700 may include a display system 1702 (e.g., comprising a display and/or a touch-sensitive surface) and/or one or more cameras 1704. In some non-limiting embodiments, the display system 1702 and/or one or more front-facing cameras 1704a may be provided at a front side of the device 1700, e.g., as indicated in FIG. 17. Additionally, or alternatively, one or more rear-facing cameras 1704b may be provided at a rear side of the device 1700. In some embodiments comprising multiple cameras 1704, some or all of the cameras may be the same as, or similar to, each other. Additionally, or alternatively, some or all of the cameras may be different from each other. In various embodiments, the location(s) and/or arrangement(s) of the camera(s) 1704 may be different than those indicated in FIG. 17. In various embodiments, cameras 1704 include lens(es) 1705. Image sensors (e.g., image sensor 1700) may receive light that passes through lens(es) 1705 to reach the image sensors.

Among other things, the device 1700 may include memory 1706 (e.g., comprising an operating system 1708 and/or application(s)/program instructions 1710), one or more processors and/or controllers 1712 (e.g., comprising CPU(s), memory controller(s), display controller(s), and/or camera controller(s), etc.), and/or one or more sensors 1716 (e.g., orientation sensor(s), proximity sensor(s), and/or position sensor(s), etc.). In some embodiments, the device 1700 may communicate with one or more other devices and/or services, such as computing device(s) 1718, cloud service(s) 1720, etc., via one or more networks 1722. For example, the device 1700 may include a network interface that enables the device 1700 to transmit data to, and receive data from, the network(s) 1722. Additionally, or alternatively, the device 1700 may be capable of communicating with other devices via wireless communication using any of a variety of communications standards, protocols, and/or technologies.

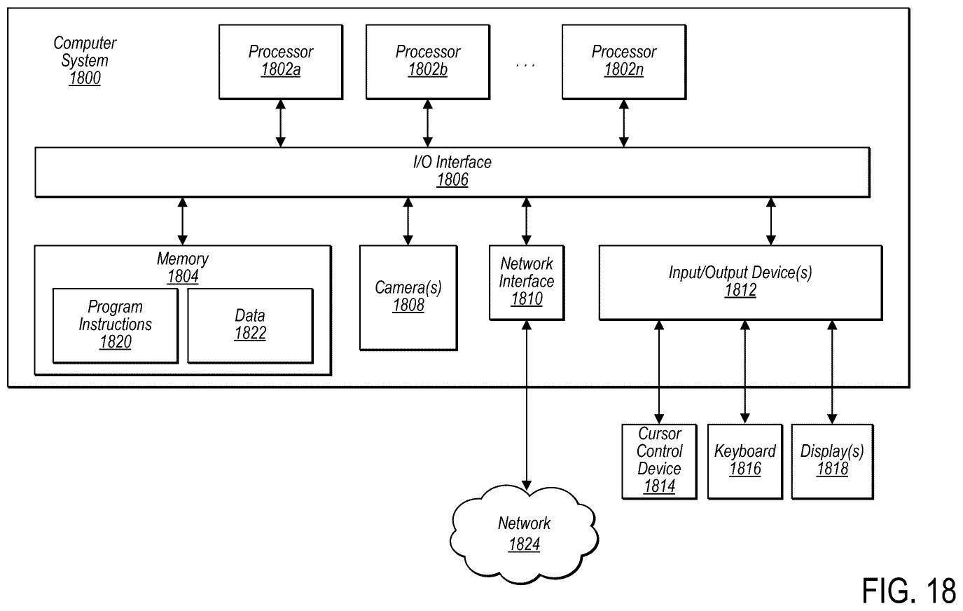

FIG. 18 illustrates a schematic block diagram of an example computing device, referred to as computer system 1800, that may include or host embodiments of an image capturing device (e.g., a camera) having an image sensor, according to some embodiments. In addition, computer system 1800 may implement methods for controlling operations of the camera and/or for performing image processing images captured with the camera. In some embodiments, the device (described herein with reference to FIG. 18) may additionally, or alternatively, include some or all of the functional components of the computer system 1800 described herein.

The computer system 1800 may be configured to execute any or all of the embodiments described above. In different embodiments, computer system 1800 may be any of various types of devices, including, but not limited to, a personal computer system, desktop computer, laptop, notebook, tablet, slate, pad, or netbook computer, mainframe computer system, handheld computer, workstation, network computer, a camera, a set top box, a mobile device, an augmented reality (AR) and/or virtual reality (VR) headset, a consumer device, video game console, handheld video game device, application server, storage device, a television, a video recording device, a peripheral device such as a switch, modem, router, or in general any type of computing or electronic device.

In the illustrated embodiment, computer system 1800 includes one or more processors 1802 coupled to a system memory 1804 via an input/output (I/O) interface 1806. Computer system 1800 further includes one or more cameras 1808 coupled to the I/O interface 1806. Computer system 1800 further includes a network interface 1810 coupled to I/O interface 1806, and one or more input/output devices 1812, such as cursor control device 1814, keyboard 1816, and display(s) 1818. In some cases, it is contemplated that embodiments may be implemented using a single instance of computer system 1800, while in other embodiments multiple such systems, or multiple nodes making up computer system 1800, may be configured to host different portions or instances of embodiments. For example, in one embodiment some elements may be implemented via one or more nodes of computer system 1800 that are distinct from those nodes implementing other elements.

In various embodiments, computer system 1800 may be a uniprocessor system including one processor 1802, or a multiprocessor system including several processors 1802 (e.g., two, four, eight, or another suitable number). Processors 1802 may be any suitable processor capable of executing instructions. For example, in various embodiments processors 1802 may be general-purpose or embedded processors implementing any of a variety of instruction set architectures (ISAs), such as the x86, PowerPC, SPARC, or MIPS ISAs, or any other suitable ISA. Also, in some embodiments, one or more of processors 1802 may include additional types of processors, such as graphics processing units (GPUs), application specific integrated circuits (ASICs), etc. In multiprocessor systems, each of processors 1802 may commonly, but not necessarily, implement the same ISA. In some embodiments, computer system 1800 may be implemented as a system on a chip (SoC). For example, in some embodiments, processors 1802, memory 1804, I/O interface 1806 (e.g. a fabric), etc. may be implemented in a single SoC comprising multiple components integrated into a single chip. For example, an SoC may include multiple CPU cores, a multi-core GPU, a multi-core neural engine, cache, one or more memories, etc. integrated into a single chip. In some embodiments, an SoC embodiment may implement a reduced instruction set computing (RISC) architecture, or any other suitable architecture.

System memory 1804 may be configured to store program instructions 1820 accessible by processor 1802. In various embodiments, system memory 1804 may be implemented using any suitable memory technology, such as static random access memory (SRAM), synchronous dynamic RAM (SDRAM), nonvolatile/Flash-type memory, or any other type of memory. Additionally, existing camera control data 1822 of memory 1804 may include any of the information or data structures to implement the techniques described above. In some embodiments, program instructions 1820 and/or data 1822 may be received, sent or stored upon different types of computer-accessible media or on similar media separate from system memory 1804 or computer system 1800. In various embodiments, some or all of the functionality described herein may be implemented via such a computer system 1800.

In one embodiment, I/O interface 1806 may be configured to coordinate I/O traffic between processor 1802, system memory 1804, and any peripheral devices in the device, including network interface 1810 or other peripheral interfaces, such as input/output devices 1812. In some embodiments, I/O interface 1806 may perform any necessary protocol, timing or other data transformations to convert data signals from one component (e.g., system memory 1804) into a format suitable for use by another component (e.g., processor 1802). In some embodiments, I/O interface 1806 may include support for devices attached through various types of peripheral buses, such as a variant of the Peripheral Component Interconnect (PCI) bus standard or the Universal Serial Bus (USB) standard, for example. In some embodiments, the function of I/O interface 1806 may be split into two or more separate components, such as a north bridge and a south bridge, for example. Also, in some embodiments some or all of the functionality of I/O interface 1806, such as an interface to system memory 1804, may be incorporated directly into processor 1802.

Network interface 1810 may be configured to allow data to be exchanged between computer system 1800 and other devices attached to a network 1824 (e.g., carrier or agent devices) or between nodes of computer system 1800. Network 1824 may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 1810 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1812 may, in some embodiments, include one or more display terminals, keyboards, keypads, touchpads, scanning devices, voice or optical recognition devices, or any other devices suitable for entering or accessing data by one or more computer systems 1800. Multiple input/output devices 1812 may be present in computer system 1800 or may be distributed on various nodes of computer system 1800. In some embodiments, similar input/output devices may be separate from computer system 1800 and may interact with one or more nodes of computer system 1800 through a wired or wireless connection, such as over network interface 1810.

Those skilled in the art will appreciate that computer system 1800 is merely illustrative and is not intended to limit the scope of embodiments. In particular, the computer system and devices may include any combination of hardware or software that can perform the indicated functions, including computers, network devices, Internet appliances, PDAs, wireless phones, pagers, etc. Computer system 1800 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1800 may be transmitted to computer system 1800 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD-ROM, volatile or non-volatile media such as RAM (e.g. SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

What is claimed is:

1. A pixel, comprising:
a silicon substrate;
at least two photodiodes formed in the substrate;
a floating diffusion region coupled to the at least two photodiodes; and
a conversion gain selection circuit coupled to the floating diffusion region, wherein the conversion gain selection circuit is configured to determine a conversion gain for the pixel as being a first conversion gain or a second conversion gain, wherein the conversion gain selection circuit includes:
a first gate having a source coupled to a portion of the floating diffusion region, the conversion gain for the pixel being the first conversion gain when the first gate is on and the second conversion gain when the first gate is off; and
a second gate having a source coupled to a gate input of the first gate, wherein the second gate is configured to control operation of the first gate in response to receiving a first control signal at a gate input of the second gate and a second control signal at a drain of the second gate.

2. The pixel of claim 1, wherein the first conversion gain is a low conversion gain and the second conversion gain is a high conversion gain.

3. The pixel of claim 1, wherein the second gate is configured to turn on the first gate when the first control signal and the second control signal are both at high levels.

4. The pixel of claim 1, wherein the second gate is configured to turn off the first gate when either the first control signal or the second control signal are at a low level.

5. The pixel of claim 1, wherein the first control signal is a row logic control signal and the second control signal is a column logic control signal.

6. The pixel of claim 1, wherein the at least two photodiodes are photodiodes that accumulate photoelectrons when exposed to a same color spectrum of light.

7. The pixel of claim 1, wherein the at least two photodiodes include a first photodiode and a second photodiode that accumulate photoelectrons when exposed to light, and wherein the conversion gain selection circuit is configured to switch the conversion gain between transfer of accumulated photoelectrons from the first photodiode to the floating diffusion region and transfer of accumulated photoelectrons from the second photodiode to the floating diffusion region.

8. The pixel of claim 7, further comprising:
a first transfer gate coupled between the first photodiode and the floating diffusion region; and
a second transfer gate coupled between the second photodiode and the floating diffusion region.

9. The pixel of claim 8, further comprising a reset gate having a source coupled to a drain of the first gate in the conversion gain selection circuit.

10. The pixel of claim 9, wherein the first gate is positioned over and divides the floating diffusion region into portions, the portion of the floating diffusion region coupled to the source of the first gate being a first portion of the floating diffusion region, wherein a second portion of the floating diffusion region is coupled to the drain of the first gate and the source of the reset gate.

11. The pixel of claim 10, wherein the operation of the first gate includes:
when turned on, accumulated photoelectrons from the at least two photodiodes transfer into a full well capacity of the floating diffusion region that includes both the first portion and the second portion; and
when turned off, accumulated photoelectrons from the at least two photodiodes transfer in a partial well capacity of the floating diffusion region that includes only the first portion.

12. A system, comprising:
a pixel device, wherein the pixel includes:
a silicon substrate;
a first photodiode formed in the substrate, the first photodiode being configured to accumulate photoelectrons when exposed to light;
a second photodiode formed in the substrate, the second photodiode being configured to accumulate photoelectrons when exposed to light;
a floating diffusion region coupled to the first photodiode and the second photodiode;
a first transfer gate coupled between the first photodiode and the floating diffusion region;
a second transfer gate coupled between the second photodiode and the floating diffusion region;
a conversion gain selection circuit coupled to the floating diffusion region, wherein the conversion gain selection circuit is configured to set a conversion gain for the pixel device as a first conversion gain or a second conversion gain in response to one or more control signals from control logic; and
the control logic coupled to the pixel device, wherein the control logic is configured to:
receive a readout of a first analog signal output from the pixel device at the first conversion gain, the first analog signal output corresponding to photoelectrons accumulated in the first photodiode;
determine a selected conversion gain for the pixel device during readout of a second analog signal output from the pixel device, the second analog signal output corresponding to photoelectrons accumulated in the second photodiode, wherein the selected conversion gain is one of the first conversion gain or the second conversion gain determined based on a value of the first analog signal output; and
provide the one or more control signals to the conversion gain selection circuit to set the selected conversion gain for the second analog signal output.

13. The system of claim 12, wherein the first conversion gain is a low conversion gain for the pixel device.

14. The system of claim 12, wherein the conversion gain selection circuit includes:
a first gate having a source coupled to a portion of the floating diffusion region, the first conversion gain being when the first gate is on and the second conversion gain being when the first gate is off; and
a second gate having a source coupled to a gate input of the first gate, wherein the second gate is configured to control operation of the first gate in response to receiving a first control signal of the one or more control signals at a gate input of the second gate and a second control signal of the one or more control signals at a drain of the second gate.

15. The system of claim 14, wherein the first control signal is a row logic control signal and the second control signal is a column logic control signal, and wherein the second photodiode is in one of a different row or a different column in the pixel device from the first photodiode.

16. The system of claim 12, wherein the control logic is configured to determine the selected conversion gain based on a comparison of the value of the first analog signal output to a predetermined threshold.

17. The system of claim 16, wherein the control logic is configured to perform the comparison of the value of the first analog signal output to the predetermined threshold in an analog domain.

18. The system of claim 16, wherein the control logic is configured to perform the comparison of the value of the first analog signal output to the predetermined threshold in a digital domain.

19. A method, comprising:
accumulating photoelectrons in a plurality of photodiodes formed in a silicon substrate by exposing the photodiodes to light, the plurality of photodiodes being part of a pixel device;
transferring, through a first transfer gate, accumulated photoelectrons in a first photodiode to a floating diffusion region coupled to the plurality of photodiodes, the first transfer gate being coupled between the first photodiode and the floating diffusion region;
receiving, at a control logic coupled to the pixel device, a readout of a first analog signal output from the floating diffusion region at a first conversion gain, the first analog signal output corresponding to the photoelectrons accumulated in the first photodiode;
determining, at the control logic, a selected conversion gain for the pixel device during readout of a second analog signal output from the pixel device, wherein the selected conversion gain is one of the first conversion gain or a second conversion gain determined based on a value of the first analog signal output;
providing, by the control logic, a row logic control signal and a column logic control signal to a conversion gain selection circuit for setting the selected conversion gain for the second analog signal output, wherein the conversion gain selection circuit includes a first gate having a source coupled to a portion of the floating diffusion region and a second gate having a source coupled to a gate input of the first gate, the row logic control signal being received at a gate input of the second gate and the column logic control signal being received at a drain of the second gate;
transferring, through a second transfer gate, accumulated photoelectrons in a second photodiode to the floating diffusion region, the second transfer gate being coupled between the second photodiode and the floating diffusion region; and
receiving, at the control logic, a readout of the second analog signal output from the floating diffusion region at the selected conversion gain, the second analog signal output corresponding to photoelectrons accumulated in the second photodiode.

20. The method of claim 19, further comprising:
determining, at the control logic, a second selected conversion gain for the pixel device during readout of a third analog signal output from the pixel device, wherein the second selected conversion gain is one of the first conversion gain or the second conversion gain determined based on a value of the second analog signal output;
providing, by the control logic, the row logic control signal to the gate input of the second gate and the column logic control signal to the drain of the second gate for setting the second selected conversion gain for the third analog signal output;
transferring, through a third transfer gate, accumulated photoelectrons in a third photodiode to the floating diffusion region, the third transfer gate being coupled between the third photodiode and the floating diffusion region; and
receiving, at the control logic, a readout of the third analog signal output from the floating diffusion region at the second selected conversion gain, the third analog signal output corresponding to photoelectrons accumulated in the third photodiode.
